(19) United States
(12) Patent Application Publication
(10) Pub. No.: US 2010/0003486 A1
(43) Pub. Date: Jan. 7, 2010

(54) BREATHABLE, DEET-RESISTANT POLYETHER BLOCK POLYAMIDE

(75) Inventors: Basker R. Lalgudi, Chadds Ford, PA (US); Sean A. Arsenault, Philadelphia, PA (US); Gregory S. O'Brien, Downingtown, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/166,580

(22) Filed: Jul. 2, 2008

(51) Int. Cl. B32B 27/34; C08G 73/02

(52) U.S. Cl. 428/220; 525/540

(57) ABSTRACT

The invention relates to a polyether block amide film, having both resistance to N,N-diethyl-3-methylbenzamide (DEET) insecticide according to MTL-DTL-31011B along with a high level of breathability (>700 g/m²/day) according to ASTM E96 B (50% R.H. & 23° C.). The polyether block polyamides of the invention can be applied to a substrate to produce water barrier, DEET-resistant and breathable apparel.

### FIELD OF THE INVENTION

The invention relates to a polyether block amide film, having both resistance to N,N-diethyl-3-methylbenzamide (DEET) insecticide according to MTL-DTL-31011B along with a high level of breathability (>700 g/m²/day) according to ASTM E96 B (50% R.H. & 23° C.). The polyether block polyamides of the invention can be applied to a substrate to produce water barrier, DEET-resistant and breathable apparel.

### BACKGROUND OF THE INVENTION

N,N-diethyl-3-methylbenzamide insecticide, commonly known as DEET, is commonly used as both a herbicide and an insect repellant. DEET can be applied in liquid or vapor media. Many materials, such as TPUs and COPEs tend to disintegrate or decompose due to contact with DEET over a period of time. These materials tend to be affected by DEET and their breathability is affected resulting in a level of discomfort for active wearers.

There is a need for materials that are both DEET resistant, and that are also breathable—allowing for the passage of water vapor.

The industry is seeking a highly breathable, DEET-resistant material at good economics, that can be used to make apparel by a simple process—such as through simple lamination.

Is has now been found that certain polyether block amide material can provide DEET resistance, high breathability and also act as a total water barrier. While not being bound by any particular theory, it is believed that DEET resistance is provided by the amide-portion of the block copolymer, while the hydrophilic polyether block provides breathability.

### SUMMARY OF THE INVENTION

The invention relates to a DEET resistant, breathable film of poly(ether-block-amide) wherein the poly(ether-block-amide) comprises,

a) 50 to 90 weight percent of polyamide blocks; and

b) 10 to 50 weight percent of polyether blocks, where the film passes MLT-DTL-31011B for DEET resistance, and has a breathability of greater than 700 g/m²/day as measured by ASTM E96B.

### DETAILED DESCRIPTION OF THE INVENTION

The invention relates to polyether block polyamides that can be used to provide material that is both DEET-resistant and breathable, and can be used to laminate apparel substrates.

The poly(ether block amide) polymers, such as PEBAX resins from Arkema Inc., result from the polycondensation of polyamide blocks containing reactive ends with polyether blocks containing reactive ends. Examples include, but are not limited to:
1) Polyamide blocks containing diamine chain ends with polyoxyalkylene blocks containing carboxylic chain ends.
2) Polyamide blocks containing dicarboxylic chain ends with polyoxyalkylene blocks containing diamine chain ends obtained by cyanoethylation and hydrogenation of aliphatic dihydroxylated alpha-omega polyoxyalkylenes known as polyether diols.
3) Polyamide blocks containing dicarboxylic chain ends with polyether diols, the products obtained in this particular case being polyetheresteramides.

Three types of copolymer containing polyamide blocks and polyether blocks may be distinguished. According to a first type, the polyamide blocks containing dicarboxylic chain ends are derived, for example, from the condensation of α, ω-aminocarboxylic acids, of lactams or of dicarboxylic acids and diamines in the presence of a chain-limiting dicarboxylic acid. As an example of an α, ω-aminocarboxylic acid, mention may be made of aminoundecanoic acid, as examples of lactams, mention may be made of caprolactam and lauryllactam, as examples of dicarboxylic acids, mention may be made of adipic acid, decanedioic acid and dodecanedioic acid, and as an example of a diamine, mention may be made of hexamethylenediamine. Advantageously, the polyamide blocks are made of polyamide 12 or of polyamide 6.

According to a second type, the polyamide blocks result from the condensation of one or more α, ω-aminocarboxylic acids and/or of one or more lactams containing from 6 to 12 carbon atoms in the presence of a dicarboxylic acid containing from 4 to 12 carbon atoms, and are of low mass, i.e. they have an Mₙ of from 400 to 1000. As examples of α, ω-aminocarboxylic acids, mention may be made of aminoundecanoic acid and aminododecanoic acid. As examples of dicarboxylic acids, mention may be made of adipic acid, sebacic acid, isophthalic acid, butanedioic acid, 1,4-cyclohexyldicarboxylic acid, terephthalic acid, the sodium or lithium salt of sulphoisophthalic acid, dimerized fatty acids (these dimerized fatty acids have a dimer content of at least 98% and are preferably hydrogenated) and dodecanedioic acid HOOC—(CH₂)₁₀—COOH. Examples of lactams which may be mentioned are caprolactam and lauryllactam. Polyamide blocks obtained by condensation of lauryllactam in the presence of adipic acid or dodecanedioic acid and with an Mₙ of 750 have a melting point of 127-130° C.

According to a third type, the polyamide blocks result from the condensation of at least one α, ω-aminocarboxylic acid (or a lactam), at least one diamine and at least one dicarboxylic acid. The α, ω-aminocarboxylic acid, the lactam and the dicarboxylic acid may be chosen from those mentioned above. The diamine may be an aliphatic diamine containing from 6 to 12 atoms and may be arylic and/or saturated cyclic. Examples which may be mentioned are hexamethylenediamine, piperazine, 1-aminoethylpiperazine, bisaminopropylpiperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4-aminocyclohexyl)methane (BMACM).

In the second and third types, the various constituents of the polyamide block and their proportion may be chosen in order to obtain a melting point of less than 150° C. and advantageously between 90° C. and 135° C.

The number-average molar mass of the polyamide blocks is between 300 and 15 000 and preferably between 600 and 5 000. The mass Mₙ of the polyether blocks is between 100 and 6 000 and preferably between 200 and 3 000.

The polyamide portion of the block may be formed by Polymers containing polyamide blocks and polyether blocks are disclosed in patents U.S. Pat. No. 4,331,786; U.S. Pat. No. 4,115,475; U.S. Pat. No. 4,195,015; U.S. Pat. No. 4,839,441; U.S. Pat. No. 4,864,014; U.S. Pat. No. 4,230,838; and U.S. Pat. No. 4,332,920.

Copolyamides with a low melting point are disclosed in patents U.S. Pat. No. 4,483,975, DE 3 730 504 and U.S. Pat. No. 5,459,230, and the same proportions of the constituents are adopted for the polyamide blocks.

Copolyamides with a low melting point are disclosed in patents U.S. Pat. No. 4,483,975, DE 3 730 504 and U.S. Pat. No. 5,459,230, and the same proportions of the constituents are adopted for the polyamide blocks.

The polyether blocks may contain units other than ethylene oxide units, such as, for example, propylene oxide or polytetrahydrofuran (which leads to polytetramethylene glycol sequences). It is also possible to use simultaneously PEG blocks, i.e. those consisting of ethylene oxide units, PPG blocks, i.e. those consisting of propylene oxide units, and PTMG blocks, i.e. those consisting of tetramethylene glycol units, also known as polytetrahydrofuran. PPG or PTMG blocks are advantageously used. The amount of polyether blocks in these copolymers containing polyamide and polyether blocks is advantageously from 10% to 50% by weight of the copolymer and preferably from 35% to 50%.

The number-average molar mass Mₙ of the polyamide sequences can be between 500 and 10 000 and preferably between 500 and 6000. The mass Mₙ of the polyether sequences can be between 100 and 6000 and preferably between 200 and 3000.

The copolymers containing polyamide blocks and polyether blocks may be prepared by any means for attaching the polyamide blocks and the polyether blocks. In practice, two processes are essentially used, one being a 2-step process, the other a one-step process.

The 2-step process consists firstly in preparing polyamide blocks containing carboxylic ends by condensation of the polyamide precursors in the presence of a chain-limiting dicarboxylic acid and then, in a second step, in adding the polyether and a catalyst.

Once the polyamide containing carboxylic acid ends has been prepared, the polyether and a catalyst are then added. The polyether may be added in one or more portions, as may the catalyst.

The catalyst is defined as being any product which facilitates the bonding of the polyamide blocks and the polyether blocks by esterification. The catalyst is advantageously a derivative of a metal (M) chosen from the group formed by titanium, zirconium and hafnium.

This process and these catalysts are disclosed in patents U.S. Pat. No. 4,332,920, U.S. Pat. No. 4,230,838, U.S. Pat. No. 4,331,786, U.S. Pat. No. 4,252,920, JP 07145368A, JP 06287547A and EP 613919.

In the poly(ether block amide) of the invention, the polyether blocks are present at from 10 to 50 weight percent, preferably from 20 to 40 weight percent, and most preferably about 30 weight percent. The polyamide blocks are present at from 50 to 90 weight percent, preferably from 60 to 80 weight percent, and most preferably about 70 weight percent.

The proper ratio of polyamide to polyether blocks can be found in a single poly(ether block amide), or a blend of two or more different composition poly(ether block amide)s can be used with the proper average composition. In one embodiment, it was found to advantageous to blend a block copolymer having a high level of polyamide groups with a block copolymer having a higher level of polyether blocks, to produce a blend having an average level of polyether blocks of about 20 to 40 weight percent of the total blend of poly(amid-block-ether) copolymers, and preferably about 30 to 35 weight percent. In a preferred embodiment, the blend of two different poly(ether-block-amide)s contains at least one block copolymer having a level of polyether blocks below 35 weight percent, and a second poly(ether-block-amide) having at least 45 weight percent of polyether blocks.

A compatibilizer is admixed with the poly(ether block amide) at from 2 to 15 weight percent. The purpose of the compatibilizer is to enable proper adhesion between the polar poly(ether block amide) film and both polar and non-polar substrates. The compatibilizer could be any substance that serves to increase this adhesion. Preferably the film containing the compatibilizer will be clear. Useful compatibilizers include, but are not limited to, a functionalized polyethylene (ie. maleic anhydride functionalized, as EXXELOR VA1801 from Exxon Mobil Chemicals); an epoxy-functional or maleic anhydride functional alpha olefin (such as LOTADER from Arkema, Inc.), or a functionalized vinyl acetate copolymer. One of ordinary skill in the art, from the function of the compatibilizer and the examples given, can imagine other compatibilizers. When the film is adhered to a substrate by use of an adhesive, there is no need for a compatibilizer in the poly(ether block amide) film composition.

The poly(ether block amide) of the invention can be made into films of any thickness by known means. Film extrusion or blown film extrusion processes are examples of means to form a useful film. Useful films for the invention are from 1 to 100 microns. The films can then be laminated onto a substrate, to provide breathability and DEET resistance. The films can also be attached to a substrate by use of an adhesive.

The films can be easily laminated onto different woven and non-woven substrates. In a preferred embodiment, the substrates are made primarily of synthetic material. In the process of making DEET-resistant apparel, the breathable poly(ether block amide) film of the invention is laminated or adhered to the inside of the apparel.

Materials treated with the poly(ether block amide) of the invention have both resistance to N,N-diethyl-3-methylbenzamide (DEET) insecticide according to MTL-DTL-31011B along with a high level of breathability (>700 g/m²/day) according to ASTM E96 B (50% R.H. & 23° C.). The coated material is flexible enough for manufacturing into apparel.

Coated materials of the invention can be used to make apparel providing DEET protection. Examples of apparel in which these material would find use include, but are not limited to military jackets, camping jackets, hunting jackets, industrial jackets, gloves, headwear, pants, socks, and shoes.

### EXAMPLES

### Example 1

50 weight percent of a poly(amide-block ether) from Arkema Inc. having about 25 weight percent polyether), 40 weight percent of a poly(amide-block ether) from Arkema Inc. having about 50 weight percent polyether), and 10 weight percent of a maleic anhydride graft polyethylene are dry blended in a drum tumbler for 30 minutes. The blend is then extruded using a Leistritz 27 mm extruder at a melt temperature of 194° C. The poly(ether block amide) composition was dried for 6 hours at 60° C. The composition had a total polyether level of 32.5 percent, based on the total poly(amide-block-ether). The extruded composition was cut, resulting in pellets.

### Example 2

Example 1 was repeated, using a different ratio of the PEBAX resins, to produce A final composition of 35.00% polyether blocks.

### Example 3

The resins of Examples 1 and 2 were formed into 25 micron films by cast film extrusion. These samples were tested for MVTR, as measured by ASTM E96 B (50% RH, 23° C.) measured in g/m²/24 hr using a Mocon instrument. The results are presented in Table 1:

TABLE 1

| Example | % PE | MVTR g/m²/24 hr |
|---|---|---|
| 1 | 32.5 | 760 |
| 2 | 35 | 837 |

What is claimed is:

1. A DEET resistant, breathable film comprising poly(ether-block-amide) wherein said poly(ether-block-amide) comprises,
c) 50 to 90 weight percent of polyamide blocks; and
d) 10 to 50 weight percent of polyether blocks,
wherein said film passes MLT-DTL-31011B for DEET resistance, and has a breathability of greater than 700 g/m²/day as measured by ASTM E96B.

2. The film of claim 1 further comprising from 2 to 15 weight percent of a compatibilizer.

3. The film of claim 1, comprising 60 to 80 weight percent of polyamide blocks and 20 to 40 weight percent of polyether blocks.

4. The film of claim 3, comprising about 70 weight percent of polyamide blocks and about 30 weight percent of polyether blocks.

5. The film of claim 1, wherein said poly(ether-block-amide) is a blend of two or more different poly(ether-block-amide)s, each having a different weight percent of polyether blocks.

6. The film of claim 5, wherein said blend contains at least one poly(ether-block-amide) having a polyether block content of at least 45 weight percent, and a second poly(ether-block-amide) having a polyether block content of less than 35 weight percent.

7. The film of claim 1, wherein said film has a thickness of 0.05 to 5 mils.

8. The film of claim 7, wherein said film has a thickness of 0.2 to 2 mils.

9. An article of apparel comprising the film of claim 1 directly attached to a substrate.

10. The article of claim 9, whereby said substrate is a synthetic polymer.

11. The article of claim 9, wherein said film is attached to said substrate by a film lamination process.

12. The article of claim 9, wherein said film is attached to said substrate by an adhesive.
